(19) United States
(12) Patent Application Publication
(10) Pub. No.: US 2004/0133784 A1
(43) Pub. Date: Jul. 8, 2004

(54) Cryptographic signing in small devices

(76) Inventors: Sverre Tonnesland, Oslo (NO); Pal Bjolseth, Oslo (NO)

Correspondence Address: ERICSSON INC., 6300 LEGACY DRIVE, M/S EVR C11, PLANO, TX, 75024, US

(21) Appl. No.: 10/475,392

(22) PCT Filed: Apr. 12, 2002
(86) PCT No.: PCT/SE02/00743

(30) Foreign Application Priority Data
Apr. 25, 2001 (NO) 20012030

(51) Int. Cl. H04L 9/00

(52) U.S. Cl. 713/176

(57) ABSTRACT

A method for electronically and/or digitally signing of data on a small signing device e.g. a mobile phone is disclosed. The method includes a comparison of the data to be signed with one or more set of attributes pre-stored on the signing device and displaying the attribute(s) on said signing device if said data is matching all, a part of or parts of the pre-stored set of attributes. The user of the signing device is then requested to sign the data on basis of the displayed attributes.

### FIELD OF THE INVENTION

The invention is related to networked computing devices, especially when cryptographic signing is being used to achieve non-repudiation, access control, user verification, etc.

### BACKGROUND OF THE INVENTION

Many kinds of applications, e.g. electronic commerce (e-commerce) or mobile commerce (m-commerce), require the ability to provide persistent proof that someone has authorized a transaction. Also, signing of electronic material, such as assignments, business reports and different kinds of forms, is expected to be customary in the near future.

E-commerce and m-commerce are rapidly growing business areas, and both public and private administrations now seem to make adjustments for allowing electronic signing. However, a breakthrough for electronic signing is dependent on secure, tamper-proof and simple procedures and solutions. The signing part has to be sure that what he/she is signing is the same as received at the receiving part. The receiving part must be sure of that the signing part is the one he/she says he/she is. Further, the signing should be simple without requiring any technical knowledge from the user, and preferably feasible independent of time and localization.

Cryptographic signatures are being used in a multitude of areas. This often involves in addition to the user, being the owner of the cryptographic signing device, a signature using system and a signature receiving system. The signature using system asks the user to perform a cryptographic signature on the data presented. The user signs and returns the signature back to the signature using system. The signature using system can pass the data that was signed and the signature to the signature receiving system. The signature receiving system has a cryptographically binding relation between what the signature using system presented to the user for signing, and what the user signed.

The PKI (Public Key Infrastructure) is a widely used system for cryptographic signing and authentication, well known by persons skilled in the art. A trusted part in a PKI system issues pairs of electronic keys, one for each user. The pair consists of one private key and one public key. The private key is only known by the user (or the user's signing device), but the public key may be known by any second part indented to receive signed data from a user. In the user's device, the object to be signed and the private key are inputs to some algorithm outputting the object in a signed condition. At the receiving part, the signed object and the public key are inputs to some other algorithm, extracting the original object from the signed one. The object will be correctly extracted only if the private key signed it. Consequently, the receiving part can be sure that that specific user, when utilizing this user's public key for extraction, signed the object.

Many electronic devices already support cryptographic signing. One example is a PC with an Internet browser installed. The browser may have one or more certificates including private keys issued from one or more trusted parts or so-called Certification Authorities (CA).

One problem with this is that a PC usually is bounded to one fixed location, and/or it is too big to be carried around everywhere. However, the need for signing materials is not limited to places in which PC's are localized or may be carried.

Further, a PC that is being online all the time or for longer time periods is very vulnerable to data sniffing, there might be a risk for intruders grabbing the private keys. For security reasons, a user then might want to utilize his/hers personal signing device for signing the material presented at the PC.

The solution of the above-mentioned problems may be small portable devices such as cellular phones. “WMLScript Language Specification”, WAP Forum describes an implementation of a function allowing WAP phones executing cryptographic signing. The WAP phone requests the user to sign a string of text by entering e.g. a PIN code for the device to cryptographically sign the string.

However, such devices, e.g. cellular phones, are characterized by being memory and processing capacity limited hardware devices where a cryptographic signing function is accessible through a defined and limited interface.

The problem then occurs when the data to be signed is too big to be presented to the user, or in a format that is not understandable to the user. The data will appear as random looking bytes or simply ignored, and the owner of such a device will not be able to understand what is being signed, let alone given the feeling that what is to be signed is actually what is being signed.

Existing solutions do not address the issue of the user being able to understand the content to be signed as part of the signing process in devices described in this document.

### SUMMARY OF THE INVENTION

The main object of the present invention is to overcome the above-identified problems and provide non-repudiation between a user, a signature using system and a signature receiving system. This is achieved by a method defined by the enclosed claim 1.

More specifically, a preferred embodiment of the present invention provides a method for electronically and/or digitally signing of data using a signing device utilizing an electronic signing system, which method includes a comparison of the data to be signed with one or more set of attributes pre-stored on the signing device and displaying the attribute(s) on said signing device if said data is matching all, a part or parts of the pre-stored set of attributes. The user of the signing device is then requested to sign the data on basis of the displayed attributes, and the resulting signature is returned to the signature user system.

### BRIEF DESCRIPTION OF THE DRAWINGS

FIG. 1 shows an example of attribute sets to be pre-loaded in the device according to the present invention.

FIG. 2 illustrates an example of a crypto enabled mobile device owner using the device keyboard to pre-program the device.

FIG. 3 illustrates an example of a crypto enabled mobile device owner using a programming tool to pre-program the device.

FIG. 4 illustrates the procedure of loading the data to be signed according to the present invention.

FIG. 5 is a flow chart showing the data flow when data is compared in the signing device according to the present invention.

FIG. 6 shows an example network when using a mobile device for signing data.

FIG. 7 shows an example of signing a document on a mobile phone according to the present invention.

FIG. 8 shows an example of signing a weather forecast on a mobile phone according to the present invention.

### PREFERRED EMBODIMENTS OF THE PRESENT INVENTION

In the following, a preferred embodiment of the present invention is described. Note that this embodiment is discussed for illustration purposes only, and does not limit the invention as it is defined in the enclosed claim 1.

The embodiment described provides a flexible way to accomplish cryptographic binding between a user and a set of data that is unreadable to human beings in its original form or that can not be presented in the crypto enabled device due to size or format of the data.

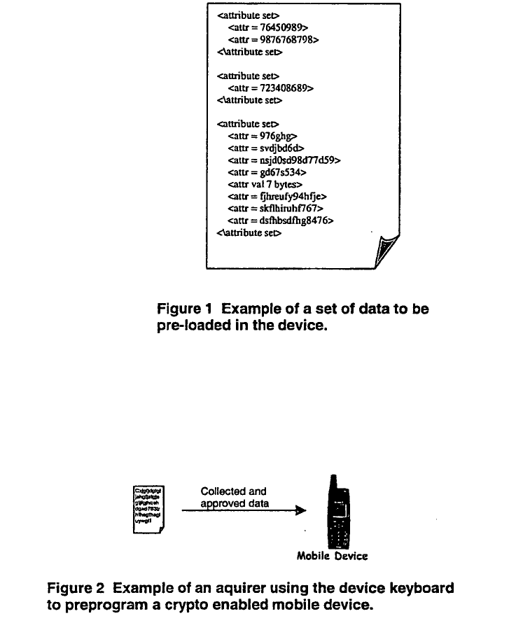

According to the present invention, when requiring a signature from the person in possession of the described device, the owner must have pre-loaded information that the said device shall compare to the data to be signed. The information is preferably in the form of sets of byte patterns, hereafter referred to as attributes, as shown in FIG. 1. The attributes may e.g be ASCII representations of textual information adjusted to be displayable on the device. Any number of sets may be defined and each set may have multiple attributes.

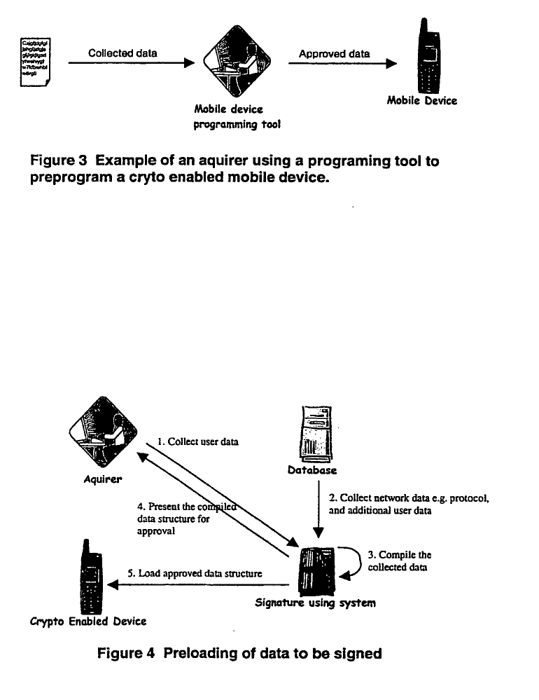

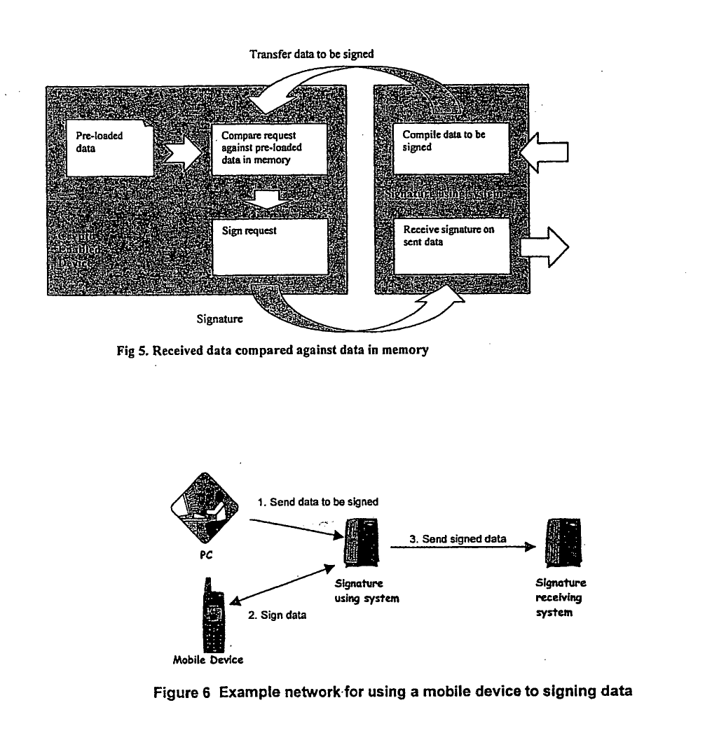

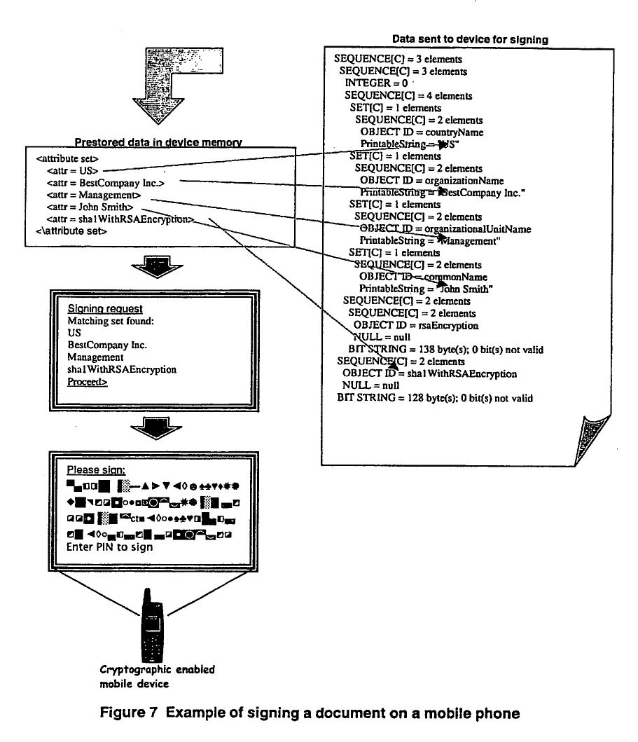

This information is loaded into the memory of the device using e.g. a device-programming tool (FIG. 3), through the device keypad (FIG. 2) or through some process where the data is downloaded into the memory of the device. The owner of the device verifies this information e.g. by browsing the data contained in the memory. When the information has been approved, some sort of identification of the approved data may be stored to prevent the data of being modified. A typical identifier would be the cryptographic hash of the data.

Upon generating a signing request, a signature using system sends the data to be signed to the device ordering the device to perform a cryptographic signing. The signature using system may be any data system, node or computer that is being in possession of the entire collected data that is to be signed. For example, the signature using system may be the user's PC having received some form requiring a signature.

The device then attempts to match the received data structure to be signed against the attribute sets stored in the device. If a match is found, the device displays the attribute set and asks if the owner wants to proceed with the signing request. The device then displays the actual data and asks the owner to enter the signing PIN. The device signs the data structure and returns the signature to the requesting signature-using system.

The original data, or a reference to it, along with the signature is relayed to the signature receiving system. The signature receiving system may be, e.g., a persistent storage using e.g. HTTP [HTTP], LDAP [LDAP], SQL [SQL], a time stamping server [TSP], some kind of digital notary service, access control server, transaction handler, PKI [PKI] based payment provider, or, e.g., a pay per view/session download server.

The sign request might e.g. be sent to the device as proprietary request utilizing a SIM Application Toolkit (SAT) application [SAT] or as a WML script with a signText( ) request.

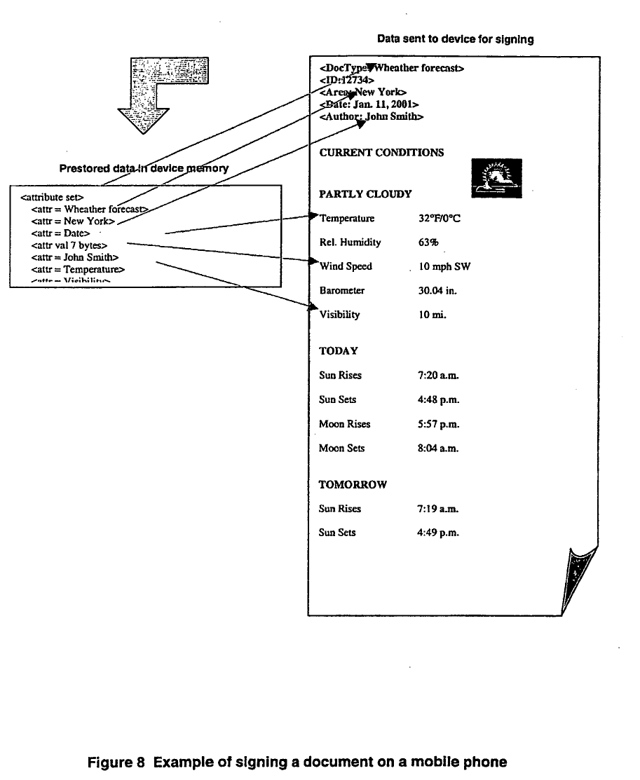

FIG. 8 illustrates an example of a signing procedure according to the present invention. A weather forecast is to be signed by a forecaster using his/her personal cryptographically enabled mobile device to sign the forecast before it's stored on the file server. The mobile device has been programmed to look for certain data as specified in the attribute set. The device displays the attributes. In this case, the device also displays the 7 bytes following the Date attribute. The <attr val 7 bytes> tag instructs the device to treat the bytes immediately following the “Date” byte pattern specified with <attr=Date>, as ASCII characters thereby making it possible to also display some dynamic content on the device.

The main advantage of the present invention is that it makes the user able to understand what he/she is signing even on small devices. The user knows that essential information in the signing request is correct before the data is signed. Any data that may be sent to the device/signed in the device may be understood and verified by the user before performing the signature. The present invention increases a signing part's freedom of movement, as he/she may use portable cryptographic enabled devices even for different types of data.

Still another advantage of the present invention is that it allows the user's private key to be separated from the signature using system to which generally external networks are connected (e.g. PC-s to the Internet). The risk of intruders grabbing private signing keys is consequently reduced.

Still another advantage of the invention is that minimal adjustments in the signature using system are required. The invention in its simplest form may transfer the data to be signed to the signing device unchanged, while the signing device is taking care of the comparison and the extraction of the data to be displayed for the user.

Above, the present invention is described by means of specific examples. However, other embodiments applicable in any scenarios where data has to be signed and understood by a human using a small cryptographic device being within the scope of the invention as defined by the following claims may be utilized.

### REFERENCES

[PKCS#1] RSA Cryptography Standard

http://www.rsasecurity.com/rsalabs/pkcs/

[PKCS#7] Cryptographic Message Syntax Standard

http://www.rsasecurity.com/rsalabs/pkcs/

(WAPArch) “WAP Architecture Specification”

http://www.wapforum.org/what/technical.htm

[WML] “Wireless Markup Language”, WAP Forum

http://www.wapforum.org/what/technical.htm

[WMLScript] “WMLScript Language-Specification”, WAP Forum

http://www.wapforum.org/what/technical.htm

[WMLCrypto] “WMLScript Crypto Library Specification”, WAP Forum

http://www.wapforum.org/what/technical.htm

[HTTP] HyperText Transfer Protocol

RFC 2069

http://www.ietf.org/rfc/rfc2068

[LDAP] Lightweight Directory Access Protocol

RFC 2559

http://www.ietf.org/rfc/rfc2559

[SQL] Structured Query Language

http://www.sql.org

1. A method for electronically and/or digitally signing of a data object using a signing device utilizing an electronic signing system, characterized in
comparing a pre-defined part of said data object that is being extracted from the data object in the signing device with a set of attributes pre-stored on said signing device
displaying whole or parts of said set of attributes on said signing device if said part of the data object is matching the pre-stored set of attributes,
requesting a user of the signing device to execute a cryptographical signing of said data object utilizing said electronic signing system after having approved the displayed whole or parts of said set of attributes.

2. A method according to claim 1, characterized in that one or more of the attributes comprise dynamic data.

3. A method according to claim 1 or 2, characterized in that said signing request is sent to the signing device as a request utilizing a SIM Application Toolkit (SAT) application or as a WML script with a signText( ) request.

4. A method according to claims 1-3, characterized in the following steps before the comparing step:
in a signature using system, compiling said data object for being compatible to the signing device, transferring said compiled data object to said signing device.

5. A method according to claim 4, characterized in the following step after the requesting step:
returning a signature as a result of said signing to said signature-using system.

6. A method according to claim 4 or 5, characterized in that the signing device is a small cryptographic enabled device using a certain protocol and the signature using system is adjusted to compile said part of the data object into said protocol.

7. A method according to claim 6, characterized in that said protocol is WAP (Wireless Application Protocol) and the signing device is a WAP enabled mobile device.

8. A method according to any of the preceding claims, characterized in that said electronic signing system is using a private/public key.

9. A method according to any of the preceding claims, characterized in that said data is a document, a form, an assignment, a transaction or a PKI (Public Key Infrastructure) certificate request.

10. A method according to claims 7-9, characterized in that the signing is executed by means of the WAP 1.2 signText( )functionality.

11. A method according to claims 7-9, characterized in that the signing is executed by means of a cryptographic sign application implemented using the SIM Application Toolkit (SAT).
